(19) United States
(12) Patent Application Publication
(10) Pub. No.: US 2025/0307496 A1
(43) Pub. Date: Oct. 2, 2025

(54) INCORPORATING RANDOM BOUNDARY CONDITION IN TERMS OF EPISTEMIC AND ALEATORY UNCERTAINTIES IN DIGITAL TWIN VIRTUAL ENTITIES

(71) Applicant: Dell Products L.P., Round Rock, TX (US)

(72) Inventors: Herberth Birck Fröhlich, Florianópolis (BR); Marcus Vinicius Libardi Pazini, Caxias do Sul (BR); Vinicius Michel Gottin, Rio de Janeiro (BR)

(21) Appl. No.: 18/624,219

(22) Filed: Apr. 2, 2024

(51) Int. Cl. G06F 30/27; G06F 111/10

(52) U.S. Cl. CPC G06F 30/27; G06F 2111/10

(57) ABSTRACT

Accounting for uncertainties in models and digital twins. A database is constructed by sampling from prior distributions of variables including epistemic variables and aleatoric variables. A model, such as a variational auto-encoder, is trained using the data stored in the database. Data from the database is input to an encoder portion of the model and the model is trained to account for uncertainties by concatenating epistemic variables to a sample of a latent space prior to proceeding with the decoder portion of the model. Once trained, a vector that includes a sample from the latent layer space and a sample from a prior distribution (or measured values) are input to the decoder to generate a solution that may be used by a digital twin. Advantageously, the prior distribution of the epistemic variables can be updated over time. The updated prior distribution improves operation of the model without retraining the model.

### COPYRIGHT AND MASK WORK NOTICE

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### FIELD OF THE INVENTION

Embodiments of the present invention generally relate to virtual entities and stochastic events. More particularly, at least some embodiments of the invention relate to systems, hardware, software, computer-readable media, and methods for incorporating uncertainties into virtual entities such as digital twins.

### BACKGROUND

Technology has advanced to the point where it is possible to represent industrial processes as virtual entities, an example of which is a digital twin. Digital twins provide a slew of benefits. Digital twins enable simulations to be performed that represent real world scenarios and aid in developing solutions to various concerns and problems. For example, digital twins can be used to monitor and simulate the production and transport of goods in diverse industries and in a large variety of different applications. Digital twins can simulate various interactions between processes. Digital twins facilitate making adjustments in real-world systems and processes. These interactions and simulations allow tests to be performed and decisions to be made with the goal of optimizing the relevant process (e.g., manufacturing of goods, delivery of services). Digital twins thus represent real world processes in a digital domain and allow real-world processes to be evaluated and followed digitally.

However, digital twins do not account for the uncertainty of real world processes. The inability of digital twins to effectively account for uncertainty may lead to a gap between reality and the simulation. This gap may lead, for example, to misinterpreted result, misinformed decisions and financial loss.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1A discloses aspects of a real-world system/process to be modeled in a manner that accounts for stochastic events;

FIG. 1B discloses aspects of a simulation engine configured generate a database for use in training a model that accounts for real-world uncertainties;

FIG. 2A discloses aspects of training a model to account for uncertainties or stochastic events;

FIG. 2B discloses aspects of generating inferences with a trained model that account for uncertainties;

FIG. 3A discloses aspects of a real world problem;

FIG. 3B discloses aspects of generating a synthetic database for the real world problem in FIG. 3A;

FIG. 4 discloses a comparison between results of a digital twin based on a prior distribution and results of a digital twin based on measurements taken during operation;

FIG. 5 discloses aspects of improving results of a model using additional data rather than retraining the model; and

FIG. 6 discloses aspects of a computing device, system, or entity.

### DETAILED DESCRIPTION OF SOME EXAMPLE EMBODIMENTS

Embodiments of the present invention generally relate to virtual entities and to simulating real-world objects/processes digitally. More particularly, at least some embodiments of the invention relate to systems, hardware, software, computer-readable media, and methods for incorporating uncertainty into virtual entities such as digital twins. Incorporating uncertainty allows more confidence to be placed in the results of the model and/or the simulation result.

Embodiments of the invention are discussed in the context of digital twins, but may be applied to other virtual entities. Embodiments of the invention relate to introducing uncertainty into digital twins to more effectively represent real world scenarios and processes. Embodiments of the invention introduce stochastic parameters such that the stochasticity can be represented or reflected in digital twin simulations. The digital twin is able to account for at least a portion of the stochasticity of the system/process. Thus, embodiments of the invention account for uncertainties of processes simulated by digital twins, provide a model to replace physics-based simulations, and regulate the uncertainty level of the model using, in one example, stochastic boundary conditions.

Embodiments of the invention incorporate and regulate uncertainty in digital twin simulations. In some example embodiments, stochastic boundary conditions (SBCs) and generative machine learning (ML) algorithms act as a surrogate model for more computationally expensive physics-based simulations. Embodiments of the invention may also capture the uncertainty of real-world processes and produce data or results that can be utilized for more robust decision making/optimization of processes. Advantageously, real-world variations are likely not sufficient to invalidate the model's outcome.

Embodiments of the invention may model a total uncertainty (χ). In one example, the uncertainty is separated into two classes. Epistemic uncertainty (α) is a type of uncertainty about values that can be measured and that can be reduced through better measurements or more data. Aleatory uncertainty (β) is a type of uncertainty that cannot be affected by collecting more data.

In one example, random epistemic variables that are inherent to the process being simulated are mapped as follows: U={u₁, u₂, . . . , uₙ}. This mapping U is an example of epistemic boundary conditions (EBCs). The non-deterministic variables are examples of aleatory boundary conditions (ABCs) and are mapped as follows: V={v₁, v₂, . . . , vₙ}. The set of all random variables are defined as: SBCs (Ω={U∪V}).

In one example, a physics-based model (e.g., Finite Element Method Solver) may be executed to alter or use the SBCs to generate a dataset D. This may allow conditions to be altered regarding a prior understanding (e.g., using a prior distribution of the SBCs) of the process being evaluated. For example, temperatures in a process range from 20° C. to 35° C., or pressures are between 1 atm up to 1.25 atm.

The dataset D may be used to construct a generative model M (e.g., a variational auto-encoder (VAC)). During training, in the case of a VAC, embodiments of the invention append EBCs in a latent dimension of the VAC. In other generative models, the information may be incorporated by differently (e.g., as a residual layer).

Once the model is trained, the model M can be used to generate a multitude of physically possible results. This allows a statistical analysis to be applied in order to characterize the process.

If measuring the EBCs is possible during operation, the belief or prior distribution of the U variables can be updated with the historical data (or data obtained over time) and used for future simulations. The prior belief or distribution may be updated to a posterior belief or distribution. This advantageously improves results of the model with no need to retrain the model. In addition, the variables measured in real-time can be used by the model to output a simulated result of the real-world process that is affected only by aleatory uncertainty as the epistemic variables are measured and the epistemic uncertainty of the model is zero in this example.

As previously stated, physics-based simulations are often used in digital twins. However, physics-based simulations do not account for real-world stochasticity in real-world processes. Embodiments of the invention incorporate aleatoric and epistemic uncertainties into virtual entities such as digital twins. Stated differently, embodiments of the invention improve the quality of simulations generated by a digital twin. Embodiments of the invention further preserve the characteristics of the aleatoric and epistemic uncertainties. Adding uncertainties results in a better representation, in the digital world, of real-world processes.

Although incorporating uncertainties results in a better representation of real-world life processes in the digital realm, embodiments of the invention do not necessarily allow the uncertainties to be uncontrolled. In one example, the aleatoric and epistemic uncertainties are separated. This allows aleatoric uncertainties to be minimized by acquiring process knowledge and observations. In one example, in a model where the parameters generate or are associated with aleatory and epistemic uncertainty, the epistemic and aleatory parameters are inserted separately to aid in generating solutions that account for the uncertainty that may be untraceable.

Embodiments of the invention thus relate to systems and methods for incorporating uncertainties into digital simulations. Embodiments of the invention provide flexibility such that the output can be improved by data gathering processes without the need to retrain or build synthetic databases. Embodiments relate to the incorporating uncertainties in a reduced or latent dimension in order for a method to reproduce a combined uncertainty.

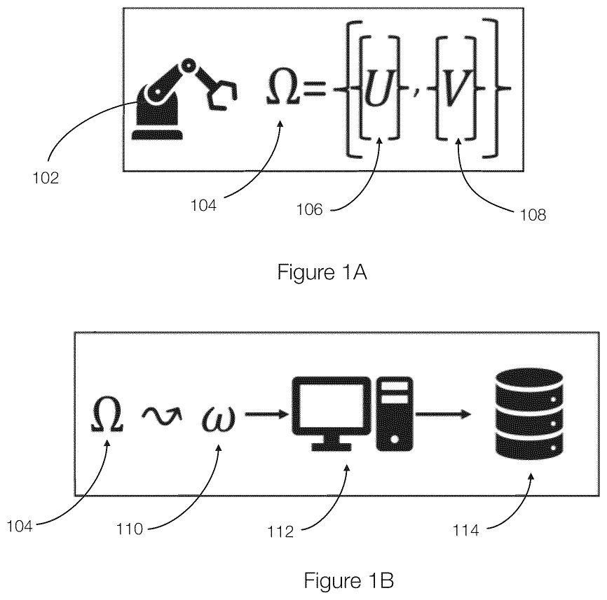

FIGS. 1A and 1B disclose aspects of conditions or uncertainties that may exist in a real-world environment. FIG. 1A illustrates a representation of a real-world system/process 102 and illustrates examples of uncertainties in the process 102. When building a model that incorporates uncertainties, a choice is made regarding the variables associated with the process 102. More specifically, epistemic variables 106 and aleatoric variables 108 may be identified. This may be performed by an expert or other person familiar with the process 102.

When identifying or determining which of the variable are aleatoric and which of the variables are epistemic, various factors may be considered. One factor may be the cost (e.g., in terms of effort, economics) of measuring a variable may be considered. For example, a there may be variable that are physically impossible or very difficult to measure. Alternatively, the economic cost of measuring the variable may be excessive or too high. These are examples of variables that may be deemed aleatoric. In contrast, some physical quantities may be easily obtained (e.g., temperature) and these variables may be deemed epistemic.

Thus, the epistemic variables 106 are mapped or defined and the aleatoric variables 108 are also mapped or defined. The union of the sets (or subsets) of epistemic variables 106 and the aleatoric variables 108 results in a set 104 (Ω) of variables.

Once these variables 106 and 108 are mapped, a prior distribution for each set 106 and 108 may be obtained or generated. The prior distribution is a probability distribution representing beliefs about the variables 106 and 108 and may be generated by a subject matter expert in one example.

FIG. 1B discloses aspects of generating a synthetic database using the set of variables and a simulation engine. Once the variables 106 and 108 are mapped and the prior distributions are available, a synthetic database 114 may be generated. In one example, a simulation engine 112 may be a physics-based simulation program (e.g., Monte Carlo) configured to perform estimations of real-world outcomes given boundary conditions, which are stored or represented as the variables 104.

In FIG. 1B, the set 104 of variables is sampled to obtain a sample 110 w. More specifically, the sample 110 w is composed of u and v values. In this example, v is aleatoric and u is epistolic and the sample 110 is built from prior distributions. The sample 110 w is used as boundary conditions and is input to the simulation engine 112. The result or output of the simulation engine 112 is stored in the database 114 (D). This process is repeated until enough simulation results are achieved or stored in the database 114. In one example, the criterion for ending the process of generating the database 114 is case dependent and may change according to the complexity of the physical phenomena.

Once the database 114 has been generated, embodiments of the invention may select a model that is capable of acting as a surrogate to the simulation engine 112. Embodiments of the invention, however, may adapt the model such that the epistemic boundary conditions can be added to the architecture/operation of the model. This makes it possible to insert and update the prior/real-time measurements of these quantities to improve the result (e.g., account for the uncertainty brought by EBCs in a final solution).

Embodiments of the invention are discussed in the context of autoencoders or variational autoencoders (VACs), where values can be appended to a latent state, or models that include residual layers.

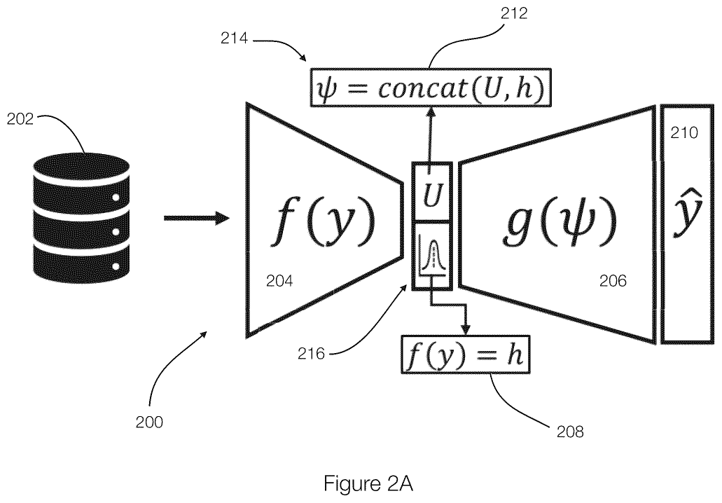

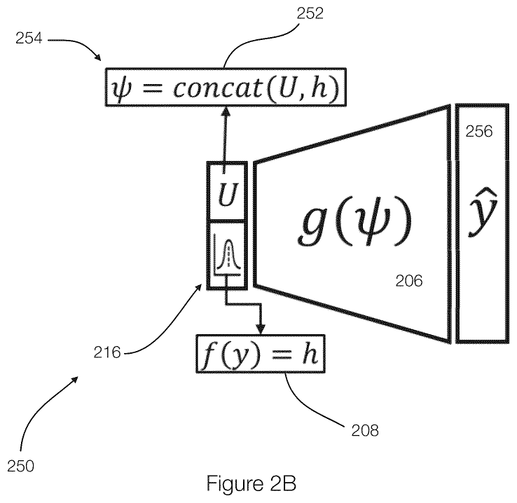

FIG. 2A discloses aspects of training a model such as a VAC. FIG. 2A illustrates a database 202, which is an example of the database 114, used to train a model 200. The database 202 stores outputs y of a simulation process (e.g., generated by a simulation engine). These outputs y (or samples thereof) stored in the database 202 are propagated through an encoder 204 (f(y)). The output of the encoder 204 is a hidden or latent state h. Thus, f(y)=h. When propagating results in the database 202 through the encoder 204, parameters u and o are generated and may be used to sample from a normal distribution of h.

A sample from the normal distribution of 208 h of the latent state is concatenated 212 with EBCs. The EBCs (represented as U in FIG. 2A) are known because the EBCs were used to generate the simulation results stored in the database 202.

The concatenated vector 214 (ψ) is propagated through the decoder 206 (g(ψ)) to generate a reconstructed model output 210 (ŷ). The weights of the model 200 may be updated via backpropagation. As illustrated, the architecture of the model 200 separates the aleatory uncertainty from the epistemic uncertainty, in one example, by enriching the latent dimension 11 Docket No: 16192.988 216 with epistemic information or values.

FIG. 2A thus illustrates an example of a model 200 that is trained to account for or incorporate epistemic uncertainty into the model 200.

FIG. 2B discloses aspects of generating inferences with a trained model. The model 250 is a trained example of the model 200. After learning the distribution of the latent state variables (or distribution) 208 (h), stochastic simulations can be performed using the model 250. When generating an inference, the input to the decoder 206 includes a concatenation of a vector sampled from the latent state distribution 208 and a vector from the epistemic variables (U), represented as concatenation 252 in this example.

Performing forward propagation using concatenated vector 254 (ψ) will generate an output 256 that is an approximation of the physics-based solver or simulation engine. The output 256 lies within a range of expected results.

The model 250 may have various applications. For example, the model 250 may use the real-time data collection of the epistemic variables to form a vector U that is inserted into the model, as part of the concatenation 252 or input vector 254. The model 250 then produces a simulation result (e.g., output 256) that resembles a probable real-world scenario, given that the EBCs are measured. The ABCs are accounted for by the hidden state 208 h. The output 256 can be used, by way of example, to update the state of a digital twin or in digital twin simulations. This example illustrates that the model may be used to solve or perform a simulation for a particular case when the EBCs are measured. The only uncertainty source is the aleatoric component of the uncertainties, which is represented in the distribution 208.

In another example, the model 250 may replace a deterministic physics-based simulation, which may be computationally expensive. The model 250 advantageously considers the stochastic nature of the problem or system being simulated. The model 250, may reduce the time to perform the simulation and improve the robustness of the solution with respect to stochastic events.

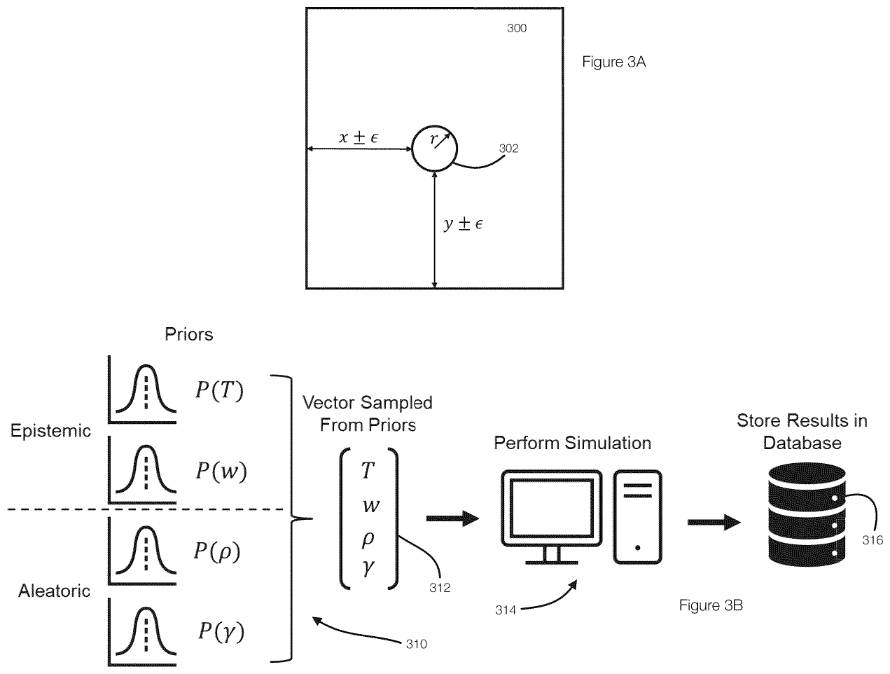

FIGS. 3A and 3B disclose aspects of an example of incorporating uncertainty into a model. FIG. 3A discloses aspects of a problem 300. In this example, a robot may be tasked with drilling a hole in a metal sheet. The hole 302 should be drilled with a certain precision. The precision, in this example, is expressed as a set of coordinates x and y and an acceptable deviation E.

FIG. 3B discloses aspects of generating a database such as a synthetic database. Prior to generating the database 316, variables that may impact or have some effect over the deviation e are identified. After identifying the variables, the variables may be separated or more specifically identified as epistemic variables or aleatoric variables.

In this example, the following variables were identified, for example by a subject matter expert. The epistemic variables include:
a) temperature of the drilling tool (T); and
b) angular speed of the drilling tool (w).

The aleatoric variables include, in this example:
a) tool wear (ρ); and
b) vibration frequency of the drilling tool (γ).

Next, prior distributions 310 are attributed to each of these variables ((T, w, ρ, γ)). These prior distributions 310 are represented as P(T), P(w), P(ρ), P(γ). In one example, these prior distributions 310 may be constructed by expert domain knowledge.

Once the epistemic and aleatoric variables are mapped, these distributions 310 (or samples thereof) are input to a simulation 314. Outputs (e.g., x and y coordinates) of the simulation 314 are stored in the database 316. The sample vector 312 is formed by sampling from the prior distributions 310 of each of the variables. The number of simulations needed such that the database 316 is representative may depend on the domain. The database 316 may store x and y values for multiple samples of T, w, ρ, γ.

Next, a model is trained. In one example, a model is selected that may be used to replace a deterministic simulator 314 and can be trained to account for the prior distributions or uncertainties. In this example, a VAC is selected and the epistemic variables (T, w) are concatenated in the latent state as previously described with a vector from the latent space h.

Embodiments of the invention include measuring the epistemic variables during operation while running the model in real time. In this case, the measured values of the epistemic variables can be directly inserted into the latent space of the VAC. This eliminates the need to use the prior distributions for the EBCs as current values may be used. Thus, the only source of uncertainty is implicitly embedded in to the h part of the hidden or latent state ψ.

This advantageously allows quick simulations to be performed in digital twins and thus allowing the uncertainty to affect the portion of the result than cannot be controlled (the aleatoric variables).

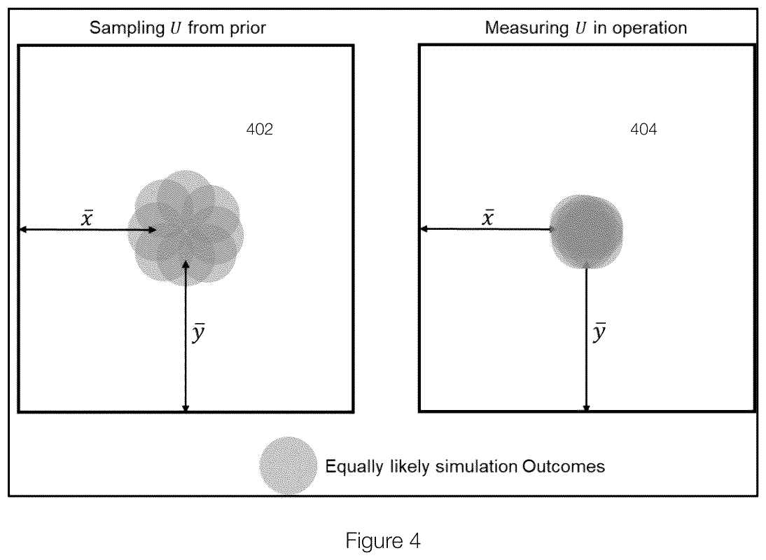

FIG. 4 discloses a comparison between results using a prior distribution of the epistemic variables and results using measurements of the epistemic variables taken during operation in a digital twin. Thus, the epistemic variables added to the latent layer of the model from the prior distribution are reflected in the plot 402. More specifically, the plot 402 illustrates simulation outcomes when sampling the epistemic variables (U) from a prior distribution. The plot 402 illustrates simulation outcomes when measuring the epistemic variables (U) during operation. The prediction variance is decreased when measuring the epistemic variables, which suggests that uncertainty (e.g., epistemic uncertainty) in the result has been reduced using a model trained to account for uncertainty of epistemic variables.

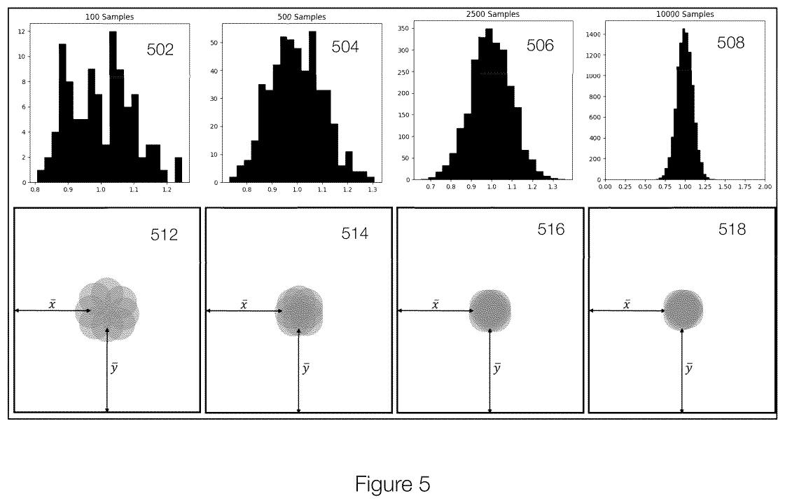

FIG. 5 discloses aspects of improving model solutions or outputs without retraining the model. As previously suggested, EBCs can be measured over time and these measurements can be used to update the prior belief or distribution. This may improve the results of the model as the distribution of epistemic variables is improved with the inclusion of more data.

More specifically, there may be situations where real time concatenations of epistemic variables and a sample from the h space cannot be achieved. In this example, the model can be improved using the historic dataset of EBCs (or distribution), which may be updated over time.

This allows a model to perform in a manner that more closely resembles real-world operation without the necessity of retraining the surrogate (the model) or building a new synthetic dataset. This is due to the possibility of directly imputing the EBCs to the latent dimension of the model to refine the output of the model.

More specifically, FIG. 5 illustrates an example of changes to a prior distribution that may occur as additional historical data is collected. The distribution 502 at 100 samples is distinct from the distributions 504, 506, and 508 at, respectively, 500, 2500, and 10000 samples.

The corresponding outcomes of the model or results for inputting samples from the distributions 502, 504, 506, and 508 into the latent dimension of the model are illustrated as plots 512, 514, 516, and 518. As additional samples are added to the dataset, the model, without retraining, can better account for the uncertainty and the benefits of the updated or posterior distribution 508 are illustrated in the plot 518. Stated differently, there is less uncertainty reflected in the plot 518 compared to the plot 512.

FIG. 5 illustrates updating the prior distribution as more samples are acquired and illustrates that the possible positions (x, y) outputted by the model have a diminished variance when using the posterior distribution in the latent state of the model.

The main advantage of this approach is its capability of using the same model to perform simulations for process in Digital Twins as this architecture allows for the use of prior and posterior distributions.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, model and model-related operations, variable selection operations, database generation operations, uncertainty related operations, digital simulation operations, or the like. More generally, the scope of the invention embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers or VMs, or any combination of these, though no particular device implementation or configuration is required for any embodiment. Similarly, data storage system components such as databases, storage servers, storage volumes (LUNs), storage disks, for example, may likewise take the form of software, physical machines, containers, or virtual machines (VMs), though no particular component implementation is required for any embodiment.

As used herein, the term ‘data’ is intended to be broad in scope. Example embodiments of the invention are applicable to any system capable of storing and handling various types of objects, in analog, digital, or other form.

It is noted that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in any way.

Embodiment 1. A method, comprising: receiving input into a model that has been trained to incorporate uncertainties into an output of the model, the input including a vector sampled from a latent space combined with a vector of epistemic variables,, wherein the latent space comprises a distribution of a latent layer of the model, wherein the latent layer inherently includes uncertainty related to aleatoric variables and wherein the model is a surrogate for a physics-based engine, and generating the output with the model, wherein the output is a simulated output of a real-world process.

Embodiment 2. The method of embodiment 1, wherein the model is incorporated

into a digital twin.

Embodiment 3. The method of embodiment 1 and/or 2, wherein the model has been trained to account for stochastic events.

Embodiment 4. The method of embodiment 1, 2, and/or 3, further comprising identifying a set of variables associated with the uncertainties, wherein the set of variables includes a set of aleatoric variables and a set of epistemic variables.

Embodiment 5. The method of embodiment 1, 2, 3, and/or 4, further comprising determining a prior distribution for the set of aleatoric variables and a prior distribution for the set of epistemic variables.

Embodiment 6. The method of embodiment 1, 2, 3, 4, and/or 5, further comprising inputting samples from the set of variables into a simulation engine and storing results of the simulation in a database.

Embodiment 7. The method of embodiment 1, 2, 3, 4, 5, and/or 6, further wherein the model has been trained using the results stored in the database.

Embodiment 8. The method of embodiment 1, 2, 3, 4, 5, 6, and/or 7, wherein epistemic variables have been inserted into a latent layer of the model during training of the model, wherein the epistemic variables are sampled from the prior distribution for the set of epistemic variables or measured from the real-world process.

Embodiment 9. The method of embodiment 1, 2, 3, 4, 5, 6, 7, and/or 8, wherein the model comprises an encoder and a decoder, wherein the latent layer is an output of the encoder.

Embodiment 10. The method of embodiment 1, 2, 3, 4, 5, 6, 7, 8, and/or 9, further comprising augmenting a prior distribution of the epistemic variables with new data over time to generate a posterior distribution for the epistemic variables, wherein the posterior distribution improves operation of the model without retraining the model.

Embodiment 11. The method of embodiment 1, 2, 3, 4, 5, 6, 7, 8, 9, and/or 10, wherein real-time epistemic variable values have been concatenated during the training of the model in the latent layer.

Embodiment 12 A system, comprising hardware and/or software, operable to perform any of the operations, methods, or processes, or any portion of any of these, disclosed herein.

Embodiment 13 A non-transitory storage medium having stored therein instructions that are executable by one or more hardware processors to perform operations comprising the operations of any one or more of embodiments 1-12.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

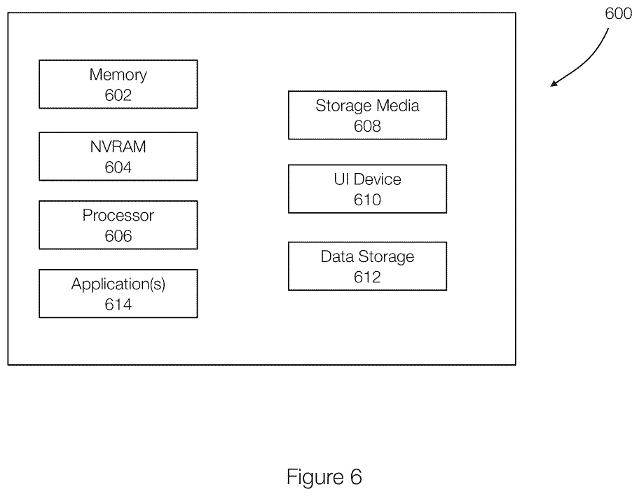

With reference briefly now to FIG. 6, any one or more of the entities disclosed, or implied, by the Figures, and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 6.

In the example of FIG. 6, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid state device (SSD) storage. As well, one or more applications 614 may be provided that comprise instructions executable by one or more hardware processors 606 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
receiving input into a model that has been trained to incorporate uncertainties into an output of the model, the input including a vector sampled from a latent space combined with a vector of epistemic variables, wherein the latent space comprises a distribution of a latent layer of the model, wherein the latent layer inherently includes uncertainty related to aleatoric variables and wherein the model is a surrogate for a physics-based engine; and
generating the output with the model, wherein the output is a simulated output of a real-world process.

2. The method of claim 1, wherein the model is incorporated into a digital twin.

3. The method of claim 1, wherein the model has been trained to account for stochastic events.

4. The method of claim 1, further comprising identifying a set of variables associated with the uncertainties, wherein the set of variables includes a set of aleatoric variables and a set of epistemic variables.

5. The method of claim 4, further comprising determining a prior distribution for the set of aleatoric variables and a prior distribution for the set of epistemic variables.

6. The method of claim 5, further comprising inputting samples from the set of variables into a simulation engine and storing results of the simulation in a database.

7. The method of claim 6, wherein the model has been trained using the results stored in the database.

8. The method of claim 7, wherein epistemic variables have been inserted into a latent layer of the model during training of the model, wherein the epistemic variables are sampled from the prior distribution for the set of epistemic variables or measured from the real-world process.

9. The method of claim 8, wherein the model comprises an encoder and a decoder, wherein the latent layer is an output of the encoder.

10. The method of claim 9, further comprising augmenting a prior distribution of the epistemic variables with new data over time to generate a posterior distribution for the epistemic variables, wherein the posterior distribution improves operation of the model without retraining the model.

11. The method of claim 9, wherein real-time epistemic variable values have been concatenated during the training of the model in the latent layer.

12. A non-transitory storage medium having stored therein instructions that are executable by one or more hardware processors to perform operations comprising:
receiving input into a model that has been trained to incorporate uncertainties into an output of the model, the input including a vector sampled from a latent space combined with a vector of epistemic variables, wherein the latent space comprises a distribution of a latent layer of the model, wherein the latent layer inherently includes uncertainty related to aleatoric variables and wherein the model is a surrogate for a physics-based engine; and
generating the output with the model, wherein the output is a simulated output of a real-world process.

13. The non-transitory storage medium of claim 12, wherein the model is incorporated into a digital twin.

14. The non-transitory storage medium of claim 12, further comprising identifying a set of variables associated with the uncertainties, wherein the set of variables includes a set of aleatoric variables and a set of epistemic variables.

15. The non-transitory storage medium of claim 14, further comprising determining a prior distribution for the set of aleatoric variables and a prior distribution for the set of epistemic variables.

16. The non-transitory storage medium of claim 15, further comprising inputting samples from the set of variables into a simulation engine and storing results of the simulation in a database, wherein the model is trained using the results stored in the database.

17. The non-transitory storage medium of claim 16, further comprising, wherein epistemic variables have been inserted into a latent layer of the model during training of the model, wherein the epistemic variables are sampled from the prior distribution for the set of epistemic variables or measured from the real-world process.

18. The non-transitory storage medium of claim 17, wherein the model comprises an encoder and a decoder, wherein the latent layer is an output of the encoder.

19. The non-transitory storage medium of claim 18, further comprising augmenting a prior distribution of the epistemic variables with new data over time to generate a posterior distribution for the epistemic variables, wherein the posterior distribution improves operation of the model without retraining the model.

20. The non-transitory storage medium of claim 19, further comprising concatenating real-time epistemic variable values during the training of the model in the latent layer.
